(19) United States
(12) Patent Application Publication
(10) Pub. No.: US 2025/0142068 A1
(43) Pub. Date: May 1, 2025

(54) STATE TRANSITION OF DEPENDENT QUANTIZATION FOR AOM ENHANCED COMPRESSION MODEL

(71) Applicant: GUANGDONG OPPO MOBILE TELECOMMUNICATIONS CORP., LTD., Dongguan (CN)

(72) Inventors: Yue YU, Palo Alto, CA (US); Haoping YU, Palo Alto, CA (US)

(21) Appl. No.: 18/841,301

(22) PCT Filed: Mar. 1, 2023
(86) PCT No.: PCT/US2023/063464

§ 371 Date: Aug. 23, 2024

Related U.S. Application Data
(60) Provisional application No. 63/268,749, filed on Mar. 1, 2022.

(51) Int. Cl. H04N 19/124; H04N 19/132; H04N 19/176

(52) U.S. Cl. CPC H04N 19/124; H04N 19/132; H04N 19/176

(57) ABSTRACT

A video encoder or decoder reconstructs a block of a video coded according to AOM Enhanced Compression Model (AV2) through dependent quantization. The video encoder or decoder accesses quantized samples associated with the block and processes the quantized samples according to an order for the block to generate respective de-quantized samples. Each quantized sample is associated with context-coded syntax elements and at least one quantized sample is associated with bypass-coded syntax elements. The processing includes obtaining a current quantized sample of the block from the quantized samples and determining a quantizer for the current quantized sample based on a parity of a partial quantization level value represented by context-coded syntax elements of a previous quantized sample. The processing further includes de-quantizing the current quantized sample based on the quantizer to generate a dequantized sample. The video encoder or decoder reconstructs the block based on the de-quantized samples.

### CROSS-REFERENCE TO RELATED APPLICATIONS

This application is National Stage of International Application No. PCT/US2023/063464, filed on Mar. 1, 2023, which claims priority to U.S. Provisional Application No. 63/268,749, filed on Mar. 1, 2022, which are hereby incorporated in their entireties by this reference.

### TECHNICAL FIELD

This disclosure relates generally to computer-implemented methods and systems for video processing. Specifically, the present disclosure involves dependent quantization for Alliance for Open Media (AOM) Enhanced Compression Model (AV2).

### BACKGROUND

The ubiquitous camera-enabled devices, such as smartphones, tablets, and computers, have made it easier than ever to capture videos or images. However, the amount of data for even a short video can be substantially large. Video coding technology (including video encoding and decoding) allows video data to be compressed into smaller sizes thereby allowing various videos to be stored and transmitted. Video coding has been used in a wide range of applications, such as digital TV broadcast, video transmission over the internet and mobile networks, real-time applications (e.g., video chat, video conferencing), DVD and Blu-ray discs, and so on. To reduce the storage space for storing a video and/or the network bandwidth consumption for transmitting a video, it is desired to improve the efficiency of the video coding scheme.

### SUMMARY

Some embodiments involve dependent quantization for AOM Enhanced Compression Model (AV2). In one example, a method for reconstructing a block for a video coded according to AOM Enhanced Compression Model (AV2) includes accessing a plurality of quantized samples of the block, each of the plurality of quantized samples associated with context-coded syntax elements and at least one of the plurality of quantized samples associated with bypass-coded syntax elements and processing the plurality of quantized samples according to an order for the block to generate respective de-quantized samples. The processing includes obtaining a current quantized sample of the block from the plurality of quantized samples; determining a quantizer for the current quantized sample based on a parity of a first quantization level value represented by context-coded syntax elements of a previous quantized sample according to the order; and de-quantizing the current quantized sample based on the quantizer to generate a de-quantized sample. The method further includes reconstructing the block based on the de-quantized samples.

In another example, a non-transitory computer-readable medium has program code that is stored thereon. The program code is executable by one or more processing devices for performing operations. The operations include accessing a plurality of quantized samples of a block of a video coded according to AOM Enhanced Compression Model (AV2), each of the plurality of quantized samples associated with context-coded syntax elements and at least one of the plurality of quantized samples associated with bypass-coded syntax elements and processing the plurality of quantized samples according to an order for the block to generate respective de-quantized samples. The processing includes obtaining a current quantized sample of the block from the plurality of quantized samples; determining a quantizer for the current quantized sample based on a parity of a first quantization level value represented by context-coded syntax elements of a previous quantized sample according to the order; and de-quantizing the current quantized sample based on the quantizer to generate a de-quantized sample. The operations further include reconstructing the block based on the de-quantized samples.

In yet another example, a method for encoding a block for a video coded according to AOM Enhanced Compression Model (AV2) includes accessing a plurality of samples associated with the block of the video and processing the plurality of samples according to an order for the block. The processing includes obtaining a current sample of the block from the plurality of samples; determining a quantizer for the current sample based on a parity of a first quantization level value represented by context-coded syntax elements of a previous sample according to the order, the previous sample further associated with bypass-coded syntax elements representing a second quantization level value; and quantizing the current sample based on the quantizer to generate a quantized sample. The method further includes encoding the quantized samples into a bitstream representing the video.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a block diagram showing an example of a video encoder configured to implement embodiments presented herein.

FIG. 2 is a block diagram showing an example of a video decoder configured to implement embodiments presented herein.

FIG. 3 depicts an example of the superblock division of a picture in a video, according to some embodiments of the present disclosure.

FIG. 4 depicts an example of a coding unit division of a superblock, according to some embodiments of the present disclosure.

FIG. 5 depicts an example of two quantizers used for dependent quantization in the prior art video coding technology.

FIG. 6 depicts an example of a state transition diagram for dependent quantization and the associated state transition table, according to some embodiments of the present disclosure.

FIG. 7 depicts an example of a process for encoding a block for a video via the dependent quantization, according to some embodiments of the present disclosure.

FIG. 8 depicts an example of a process for reconstructing a block of a video quantized using the dependent quantization, according to some embodiments of the present disclosure.

FIG. 9 depicts an example of a computing system that can be used to implement some embodiments of the present disclosure.

### DETAILED DESCRIPTION

Various embodiments can provide dependent quantization for AOM Enhanced Compression Model (AV2) video coding. As discussed above, more and more video data are being generated, stored, and transmitted. It is beneficial to increase the coding efficiency of the video coding technology thereby using less data to represent a video without compromising the visual quality of the decoded video. One aspect to improve the coding efficiency is to improve the quantization scheme of the video coding. The latest video coding standards, such as versatile video coding (VVC), have employed dependent quantization techniques. However, the dependent quantization has not been used for AV2.

In dependent quantization, more than one quantizer is available when quantizing a sample (e.g., a pixel value or a transform coefficient) of a coding block (or “block”). The quantizer used to quantize the current sample depends on the value of the previous sample in the coding block. In some examples, the value of the previous quantized sample is used to determine the state of the current sample which in turn is used to determine the quantizer for the current sample. Since the existing dependent quantization methods use the entire value of previous quantized sample of a block when determining the quantizer for a current sample of the block, directly applying these dependent quantization methods to AV2 video coding will cause significant delay.

In AV2, a quantization level is coded with two parts of syntax elements: the context-coded syntax elements and the bypass coded syntax elements. During encoding, the context-coded syntax elements for a block are coded before the bypass coded syntax elements are coded. As such, at the decoder side, the full value of a quantization level is obtained after all the context-coded syntax elements in a block are decoded. Inverse dependent quantization using existing methods will have to be delayed until the context-coded syntax elements in the block are decoded causing the increase of the delay and implementation complexity of the video decoder.

Various embodiments described herein address these problems by using context-coded syntax elements in a coding block when selecting a quantizer for a current sample of the coding block. A sample of a coding block may be a residual after inter- or intra-prediction of the coding block. The sample may be a transform coefficient of the residual in a frequency domain or the value of the residual in the pixel domain. When selecting the quantizer for a sample, only the context-coded syntax elements of a quantization level are used. This allows a quantization level to be decoded using inverse dependent quantization without waiting for the entire block to be decoded.

The following non-limiting examples are provided to introduce some embodiments. In one example, the quantizer for a current sample of a coding block is determined based on the parity of the context-based syntax elements of the previous processed sample in a coding block. In some implementations, the samples in a coding block are processed according to a pre-determined order, for example, from the highest frequency to the lowest frequency if the samples are transformed coefficients in the frequency domain. In these examples, the video encoder or decoder calculates the parity of the context-based syntax elements of the quantization level that precedes the current sample according to the pre-determined order. The calculated parity is then used to determine the state of the current sample according to a state transition table and the quantizer corresponding to the determined state is the quantizer for the current sample.

The video encoder can use the selected quantizer to quantize the current sample. The quantized samples for the coding block can then be encoded into a bitstream for the video. At the decoder side, or at the encoder side when reconstructing the block for prediction purposes, the dequantization process can determine the state of each quantized sample in the block using the method described above and subsequently determine the quantizer. The determined quantizer can be used to de-quantize the sample and the de-quantized samples of the block are then used to reconstruct the block of the video for display (at the decoder) or prediction of other blocks or pictures (at the encoder).

As described herein, some embodiments provide improvements in coding efficiency for AV2 by utilizing dependent quantization. By using only the context-coded syntax elements of the previous quantization level, the state of the current sample can be determined without waiting for the reconstruction of the full value of the previous quantization level. As a result, the decoding can be performed without significant delay and high implementation complexity while taking advantage of the improved coding efficiency provided by the dependent quantization. In addition, the proposed dependent quantization eliminates the need for using an extra flag indicating the parity of the previous level as used in VVC. The techniques can be an effective coding tool in future AV2 video coding standards.

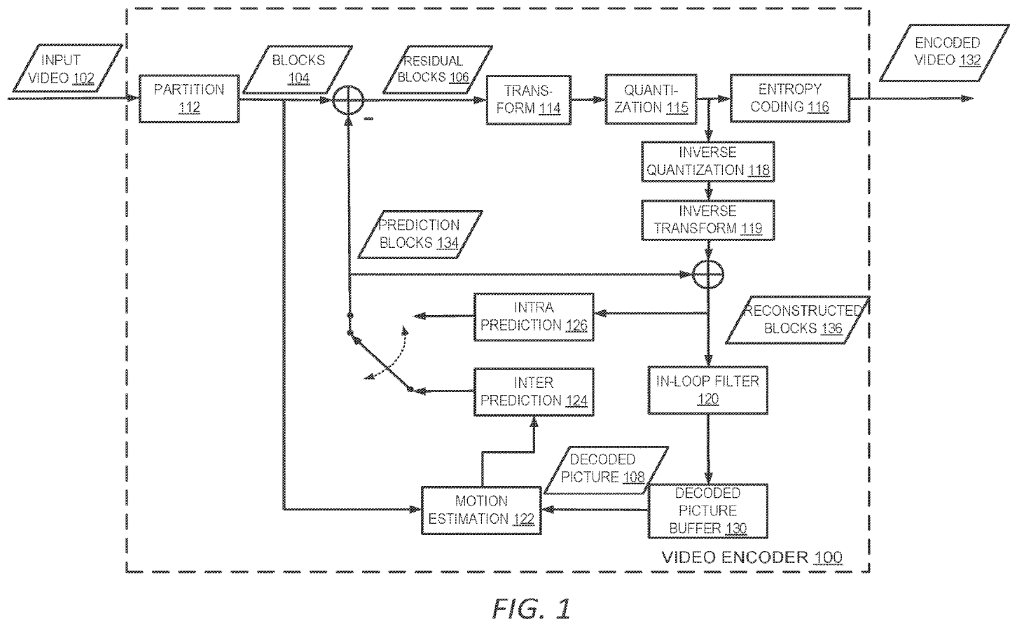

Referring now to the drawings, FIG. 1 is a block diagram showing an example of a video encoder 100 configured to implement embodiments presented herein. In the example shown in FIG. 1, the video encoder 100 implements AV2 and includes a partition module 112, a transform module 114, a quantization module 115, an inverse quantization module 118, an inverse transform module 119, an in-loop filter module 120, an intra prediction module 126, an inter prediction module 124, a motion estimation module 122, a decoded picture buffer 130, and an entropy coding module 116.

The input to the video encoder 100 is an input video 102 containing a sequence of pictures (also referred to as frames or images). The video encoder 100 is a block-based encoder and, for each of the pictures, the video encoder 100 employs a partition module 112 to partition the picture into blocks 104, and each block containing multiple pixels. The blocks may be superblocks, coding units, prediction units, and/or prediction blocks. One picture may include blocks of different sizes and the block partitions of different pictures of the video may also differ. Each block may be encoded using different predictions, such as intra prediction or inter prediction or intra and inter hybrid prediction.

Usually, the first picture of a video signal is an intra-predicted picture, which is encoded using only intra prediction. In the intra prediction mode, a block of a picture is predicted using only data from the same picture. A picture that is intra-predicted can be decoded without information from other pictures. To perform the intra-prediction, the video encoder 100 shown in FIG. 1 can employ the intra prediction module 126. The intra prediction module 126 is configured to use reconstructed samples in reconstructed blocks 136 of neighboring blocks of the same picture to generate an intra-prediction block (the prediction block 134). The intra prediction is performed according to an intra-prediction mode selected for the block. The video encoder 100 then calculates the difference between block 104 and the intra-prediction block 134. This difference is referred to as residual block 106.

To further remove the redundancy from the block, the residual block 106 is transformed by the transform module 114 into a transform domain by applying a transform on the samples in the block. A set of transform kernels is defined for intra and inter blocks. The full 2-D kernel set is generated from horizontal/vertical combinations of four 1-D transform types, yielding 16 total kernel options. The 1-D transform types are discrete cosine transform (DCT), asymmetric discrete sine transform (ADST), flipped ADST (FLIPADST), and identity transform (IDTX). The transformed values may be referred to as transform coefficients representing the residual block in the transform domain. In some examples, the residual block may be quantized directly without being transformed by the transform module 114. This is referred to as a forward skip mode.

The video encoder 100 can further use the quantization module 115 to quantize the transform coefficients to obtain quantized coefficients. Quantization includes dividing a sample by a quantization step size followed by subsequent rounding, whereas inverse quantization involves multiplying the quantized value by the quantization step size. Such a quantization process is referred to as scalar quantization. Quantization is used to reduce the dynamic range of video samples (transformed or non-transformed) so that fewer bits are used to represent the video samples.

The degree of quantization may be adjusted using the quantization step sizes. For instance, for scalar quantization, different quantization step sizes may be applied to achieve finer or coarser quantization. Smaller quantization step sizes correspond to finer quantization, whereas larger quantization step sizes correspond to coarser quantization. The quantization step size can be indicated by a quantization parameter (QP). The quantization parameters are provided in the encoded bitstream of the video such that the video decoder can apply the same quantization parameters for decoding.

The quantized samples are then coded by the entropy coding module 116 to further reduce the size of the video signal. The entropy encoding module 116 is configured to apply an entropy encoding algorithm on the quantized samples. For example, the entropy encoding algorithm include, but are not limited to, M-ary symbol arithmetic coding, where M may be 2. The entropy-coded data is added to the bitstream of the output encoded video 132.

As discussed above, reconstructed blocks 136 from neighboring blocks are used in the intra-prediction of blocks of a picture. Generating the reconstructed block 136 of a block involves calculating the reconstructed residuals of this block. The reconstructed residual can be determined by applying inverse quantization and inverse transform on the quantized residual of the block. The inverse quantization module 118 is configured to apply the inverse quantization on the quantized samples to obtain de-quantized coefficients. The inverse quantization module 118 applies the inverse of the quantization scheme applied by the quantization module 115 by using the same quantization step size as the quantization module 115. The inverse transform module 119 is configured to apply the inverse transform of the transform applied by the transform module 114 on the de-quantized samples, such as inverse DCT or inverse ADST. The output of the inverse transform module 119 is the reconstructed residuals for the block in the pixel domain. The reconstructed residuals can be added to the prediction block 134 of the block to obtain a reconstructed block 136 in the pixel domain. For blocks where the transform is skipped, the inverse transform module 119 is not applied to those blocks. The de-quantized samples are the reconstructed residuals for the blocks.

Blocks in subsequent pictures following the first intra-predicted picture can be coded using either inter prediction or intra prediction. In inter-prediction, the prediction of a block in a picture is from one or more previously encoded video pictures. To perform inter prediction, the video encoder 100 uses an inter prediction module 124. The inter prediction module 124 is configured to perform motion compensation for a block based on the motion estimation provided by the motion estimation module 122.

The motion estimation module 122 compares a current block 104 of the current picture with decoded reference pictures 108 for motion estimation. The decoded reference pictures 108 are stored in a decoded picture buffer 130. The motion estimation module 122 selects a reference block from the decoded reference pictures 108 that best matches the current block. The motion estimation module 122 further identifies an offset between the position (e.g., x, y coordinates) of the reference block and the position of the current block. This offset is referred to as the motion vector (MV) and is provided to the inter prediction module 124. In some cases, multiple reference blocks are identified for the block in multiple decoded reference pictures 108. Therefore, multiple motion vectors are generated and provided to the inter prediction module 124.

The inter prediction module 124 uses the motion vector(s) along with other inter-prediction parameters to perform motion compensation to generate a prediction of the current block, i.e., the inter prediction block 134. For example, based on the motion vector(s), the inter prediction module 124 can locate the prediction block(s) pointed to by the motion vector(s) in the corresponding reference picture(s). If there are more than one prediction blocks, these prediction blocks are combined with some weights to generate a prediction block 134 for the current block.

For inter-predicted blocks, the video encoder 100 can subtract the inter-prediction block 134 from the block 104 to generate the residual block 106. The residual block 106 can be transformed, quantized, and entropy coded in the same way as the residuals of an intra-predicted block discussed above. Likewise, the reconstructed block 136 of an inter-predicted block can be obtained through inverse quantizing, inverse transforming the residual, and subsequently combining with the corresponding prediction block 134.

To obtain the decoded picture 108 used for motion estimation, the reconstructed block 136 is processed by an in-loop filter module 120. The in-loop filter module 120 is configured to smooth out pixel transitions thereby improving the video quality. The in-loop filter module 120 may be configured to implement one or more in-loop filters, such as a de-blocking filter, or a constrained directional enhancement filter (CDEF), or an adaptive loop filter (ALF), etc.

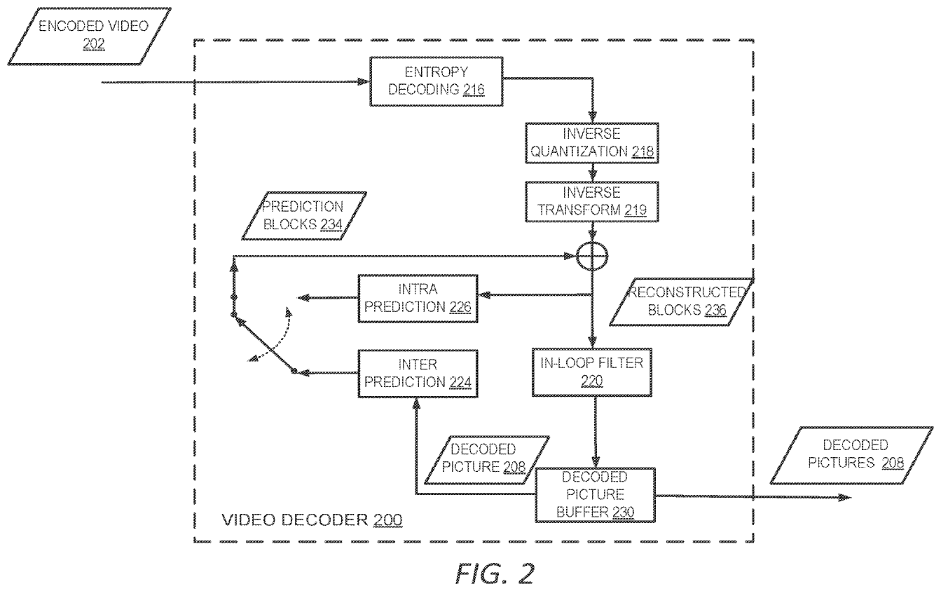

FIG. 2 depicts an example of a video decoder 200 configured to implement embodiments presented herein. The video decoder 200 processes an encoded video 202 in a bitstream and generates decoded pictures 208. In the example shown in FIG. 2, the video decoder 200 includes an entropy decoding module 216, an inverse quantization module 218, an inverse transform module 219, an in-loop filter module 220, an intra prediction module 226, an inter prediction module 224, and a decoded picture buffer 230.

The entropy decoding module 216 is configured to perform entropy decoding of the encoded video 202. The entropy decoding module 216 decodes the quantized coefficients, coding parameters including intra prediction parameters and inter prediction parameters, and other information. The entropy-decoded coefficients are then inverse quantized by the inverse quantization module 218 and subsequently inverse transformed by the inverse transform module 219 to the pixel domain. The inverse quantization module 218 and the inverse transform module 219 function similarly as the inverse quantization module 118 and the inverse transform module 119, respectively, as described above with respect to FIG. 1. The inverse-transformed residual block can be added to the corresponding prediction block 234 to generate a reconstructed block 236. For blocks where the transform is skipped, the inverse transform module 219 is not applied to those blocks. The de-quantized samples generated by the inverse quantization module 118 are used to generate the reconstructed block 236.

The prediction block 234 of a particular block is generated based on the prediction mode of the block. If the coding parameters of the block indicate that the block is intra predicted, the reconstructed block 236 of a reference block in the same picture can be fed into the intra prediction module 226 to generate the prediction block 234 for the block. If the coding parameters of the block indicate that the block is inter-predicted, the prediction block 234 is generated by the inter prediction module 224. The intra prediction module 226 and the inter prediction module 224 function similarly as the intra prediction module 126 and the inter prediction module 124 of FIG. 1, respectively.

As discussed above with respect to FIG. 1, the inter prediction involves one or more reference pictures. The video decoder 200 generates the decoded pictures 208 for the reference pictures by applying the in-loop filter module 220 to the reconstructed blocks of the reference pictures. The decoded pictures 208 are stored in the decoded picture buffer 230 for use by the inter prediction module 224 and also for output.

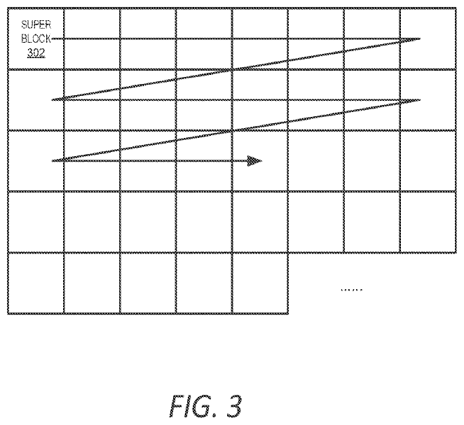

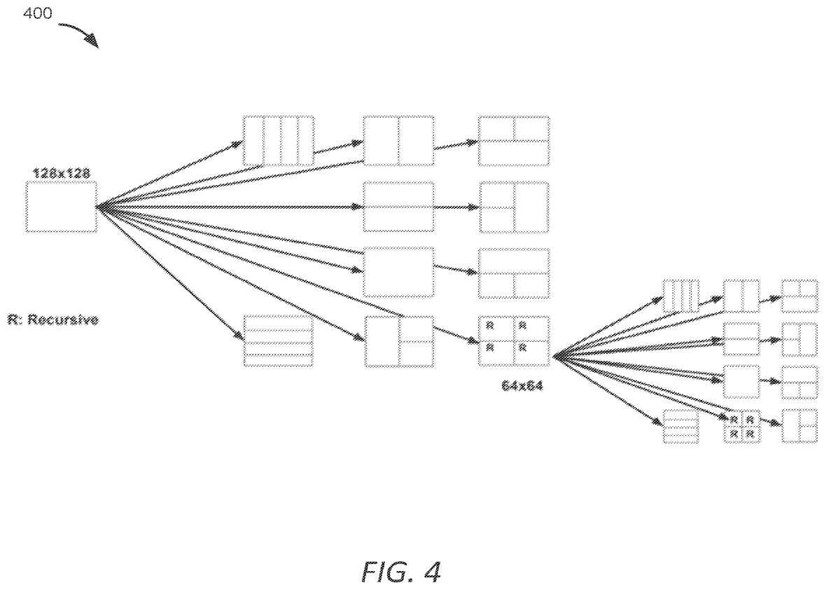

Referring now to FIG. 3, FIG. 3 depicts an example of a superblock division of a picture in a video, according to some embodiments of the present disclosure. As discussed above with respect to FIGS. 1 and 2, to encode a picture of a video, the picture is divided into blocks, such as the superblocks 302 in AV2, as shown in FIG. 3. For example, the superblocks 302 can be blocks of 128×128 pixels. The superblocks are processed according to an order, such as the order shown in FIG. 3. In some examples, each superblock 302 in a picture can be partitioned into one or more CUs (Coding Units) 402 as shown in FIG. 4, which can be used for prediction and transformation. Depending on the coding schemes, a superblock 302 may be partitioned into CUs 402 differently. For example, the CUs 402 can be rectangular or square, and each CU can be recursively divided into smaller CUs as shown in FIG. 4.

### Dependent Quantization

As discussed above with respect to FIGS. 1 and 2, quantization is used to reduce the dynamic range of samples of blocks in the video signal so that fewer bits are used to represent the video signal. In some examples, before quantization, a sample at a specific position of the block is referred to as a coefficient. After quantization, the quantized value of the coefficient is referred to as a quantization level or a level. Quantization typically consists of division by a quantization step size and subsequent rounding while inverse quantization consists of multiplication by the quantization step size. Such a quantization process is also referred to as scalar quantization. The quantization of the coefficients within a block can be performed independently and this kind of independent quantization method is used in some existing video compression standards, such as H.264, HEVC, AOM compression standard (AV1) etc. In other examples, dependent quantization is employed, such as in VVC.

For an N-by-M block, a specific scanning order may be used to convert 2-D coefficients of a block into a 1-D array for coefficient quantization and coding, and the same scanning order is used for both encoding and decoding. Typically, the scan starts from the left-top corner and stops at right-bottom corner of a block or last non-zero coefficient/level in a right-bottom direction. In other examples, the scan starts from the last non-zero sample of a block and proceeds backwards to the left-top corner. In dependent quantization, the quantization of a coefficient within a block may make use of the scanning order information. For example, it may depend on the status of the previous quantization level along the scanning order. In addition, to further improve the coding efficiency, more than one quantizer (e.g., two quantizers) is used in the dependent quantization.

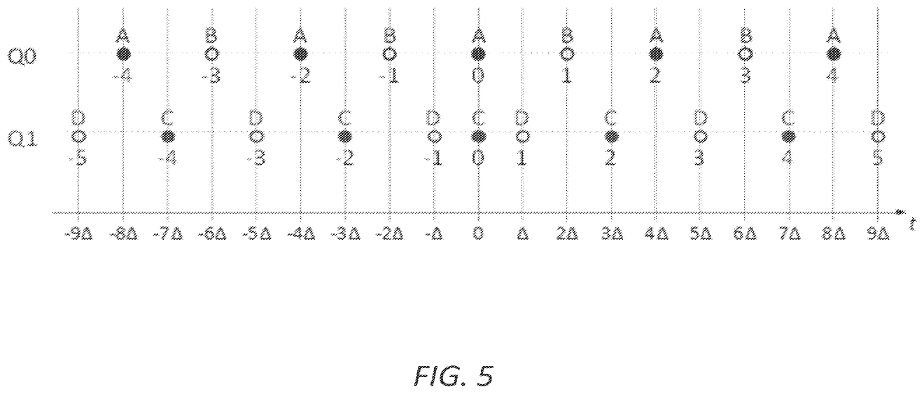

For example, as illustrated in FIG. 5, two quantizers, namely Q0 and Q1, can be used. The quantization step size, Δ, can be determined by a quantization factor which is embedded in the bitstream. Ideally, the quantizer used for quantizing the current coefficient can be explicitly specified. However, the overhead to signal the quantizer reduces the coding efficiency. Alternatively, instead of explicit signaling, the quantizer for the current coefficient can be determined and derived based on the quantization level of the coefficient immediately preceding the current coefficient. For example, a four-state model can be used and the parity of the quantization level of the previous coefficient was used to decide the state of the current coefficient. This state is then used to decide the quantizer for quantizing the current coefficient.

TABLE 1
State Transition Table for Dependent Quantization

| | |
|---|---|
| State for coefficient at | State for coefficient at location i, stateᵢ |

| location i − 1, stateᵢ₋₁ | (kᵢ₋₁ & 1) == 0 | (kᵢ₋₁ & 1) == 1 |
|---|---|---|
| 0 | 0 | 2 |
| 1 | 2 | 0 |
| 2 | 1 | 3 |
| 3 | 3 | 1 |

Table 1 shows a state transition table adopted by VVC. The state of a coefficient can take four different values: 0, 1, 2, and 3. The state for the current coefficient can be uniquely determined by the parity of quantization level immediately preceding the current coefficient in the encoding/decoding scanning order. At the start of the quantization at the encoding side or inverse quantization at the decoding side for a block, the state is set to a default value, such as 0. The coefficients are quantized or de-quantized in the pre-determined scanning order (i.e., in the same order they are entropy decoded). After a coefficient is quantized or de-quantized, the process moves on to the next coefficient according to the scanning order. The next coefficient becomes the new current coefficient and the coefficient that was just processed becomes the previous coefficient. The state for the new current coefficient state; is determined according to Table 1, where kᵢ₋₁ denotes the value of the quantization level of the previous coefficient. The index i denotes the position of coefficients or quantization levels along the scanning order. Note that in this example, the state depends on the state of the previous coefficient, stateᵢ₋₁, and the parity (kᵢ₋₁ & 1) of the level kᵢ₋₁ of the previous coefficient at location i−1. This state update process can be formulated as

$${state}_{i} = stateTransTable [ {state}_{i - 1} ] [ {k}_{i - 1} \& 1 ] \qquad ( 1 )$$

where stateTransTable represents the table shown in Table 1 and the operator & specifies the bitwise “AND” operator in two's-complement arithmetic. Alternatively, the state transition can also be specified without a look-up table as follows:

$${state}_{i} = ( 32040 ≫ ( ( {state}_{i - 1} ≪ 2 ) + ( ( {k}_{i - 1} \& 1 ) ≪ 1 ) ) ) \& 3 \qquad ( 2 )$$

where the 16-bit value 32040 specifies the state transition table. The state uniquely specifies the scalar quantizer used. In one example, if the state for the current coefficient is equal to 0 or 1, the scalar quantizer Q0 is used. Otherwise (the state is equal to 2 or 3), the scalar quantizer Q1 is used. In VVC, dependent quantization is only allowed for regular residual coding (RRC) which means that the quantization is applied to the transform coefficients of the prediction residues, instead of the prediction residues themselves.

### Residual Coding in AV2

In AV2, residual coding is used to convert the quantization levels into bit stream in video coding. After quantization, there are N×M quantization levels for an N×M block. These N×M levels may have zero or non-zero values. The non-zero levels will further be coded with an M-ray symbol arithmetic coding. The predefined scan order which depends on the transform kernel is used to convert 2-D levels into a 1-D array for sequential processing. For example, a column scan is used for 1-D vertical transform and a row scan is used for 1-D horizontal transform. A zig-zag scan is used for both 2-D transform and identity matrix (IDTX).

In the AV2 residual coding, one syntax element, all_zero, will be coded first to indicate if all levels in the current block are zero or not. If all coefficients are zero, no more syntax elements will be coded. If not all of the levels in a block are zero, several more syntax elements will be coded in the bitstream to describe the end of the block and all quantization levels as well as the signs of non-zero levels before the end of the block. For the luma component, the transform type will also be coded depending on the block type (intra-predicted block or inter-predicted block). After the index of the last non-zero level in the scan order is coded, all levels before the last non-zero level are then processed in reverse scan order. For each individual level, AV2 decomposes it into 4 symbols as follows:
(1). Sign bit: when the sign bit is 1, the level is negative; otherwise, the level is positive;
(2). Base range (BR): the BR symbol is defined with X possible outcomes {0, 1, . . . , X−2,>(X−2)}, which are based on the absolute values of the levels with an exception for the last non-zero level. Since 0 has been ruled out for the last non-zero level, the last non-zero level has X−1 possible outcomes {1, 2, . . . , X−2,>(X−2)}. In some examples, X=6. In other examples, X=4.
(3). Low range (LR): the LR symbol is determined based on the level value over the previous symbol's upper limit and is defined with Y possible outcomes {0, 1, 2, . . . , Y−2>(Y−2)}. In some examples, Y=4.
(4). High range (HR): the HR symbol is determined based on the residual value over the previous symbols' upper limit and has a range of [0, 2\hat{ }15).

To code a level V, the absolute value of V is first processed. In the example where X=4 and Y=4, if |V|∈[0, 2], the BR symbol is sufficient to signal it and the coding of |V| is terminated. Otherwise, the outcome of the BR symbol will be “>2”, and an LR symbol is used to signal |V|. If |V|∈[3, 5], this LR symbol will be able to cover the value of V and the coding is complete. If |V|>5, a second LR symbol is used to further code |V|. The LR symbol coding can be repeated up to 4 times (i.e., there can be up to 4 LR symbols for a level V). As such, the LR symbols can effectively cover the range [3, 14]. If |V|>14, an HR symbol is coded for the residual signal value (|V|−14).

In the example where X=6 and Y=4, if |V|∈[0, 4], the BR symbol is sufficient to signal it and the coding of |V| is terminated. Otherwise, the outcome of the BR symbol will be “>4”, and an LR symbol is used to signal |V|. If |V|∈[5, 7], this LR symbol will be able to cover the value of V and the coding is complete. If |V|>7, a second LR symbol is used to further code |V|. The LR symbol coding can be repeated up to 4 times (i.e., there can be up to 4 LR symbols for a level V). As such, the LR symbols can effectively cover the range [5, 16]. If |V|>16, an HR symbol is coded for the residual signal value (|V|−16).

The probability model of the symbol BR is conditioned on the previously coded levels in the same transform block. Since a level can have correlations with multiple neighboring samples, a set of spatial nearest neighbors are used to update the probability model for the current position. For 1-D transform kernels, the probability model update uses 3 coefficients after the current sample along the transform direction. For 2-D transform kernels, up to 5 neighboring coefficients in the immediate right-bottom region are used to update the probability model. In both cases, the absolute values of the reference levels are added up and the sum is considered as the context for the probability model of BR. Similarly, the probability model of symbol LR is updated by using 3 reference coefficients for 1D transform kernels, and the reference region for 2-D transform kernels is reduced to the nearest 3 coefficients.

The HR symbol is coded using Exp-Golomb code. The sign bit is only needed for non-zero quantized transform coefficients and it is coded without context updating. To improve hardware throughput, all the sign bits of AC levels within a transform block are packed together for transmission in the bit-stream, which allows a chunk of data to bypass the context updating process in the entropy coding in hardware decoders. The sign bit of the DC coefficient, on the other hand, is entropy coded using a probability model conditioned on the sign bits of the DC coefficients in the above and left transform blocks.

As described above, the state transition in the existing dependent quantization is dependent on the parity of the previous level. An extra flag indicating the parity of the previous level typically is used for this purpose in the VVC. The coding efficiency is reduced by adding such an extra flag. Further, applying the existing dependent quantization to the AV2 may cause significant delay in the video decoding and complicate the hardware implementation. In this disclosure, a state transition mechanism is proposed to improve the coding performance and reduce the complexity of dependent quantization for AV2 video coding.

According to the above discussion, a level in AV2 is coded with two parts of syntax elements. One part includes the context-coded syntax elements, including, a BR syntax element (coeff_base), a syntax element used to compute the base level of the last non-zero coefficient (coeff_base_eob) and a LR syntax element for up to four increments (coeff_br). Another part includes the syntax elements without context updating, also referred to as bypass-coded syntax elements. The bypass-coded syntax elements include HR syntax elements such as golomb_length_bit used to compute the number of extra bits required to code the coefficient and golomb_data_bit specifying the value of one of the extra bits. The syntax elements in the first part may represent a value up to 14 and the level value represented is denoted as level_context. If the level is above 14, the second part syntax elements are needed, and the value represented is denoted as level_bypass. The level of the current position, denoted as level, can be calculated as follows:

$$lev el = level\_context + level\_bypass \qquad ( 3 )$$

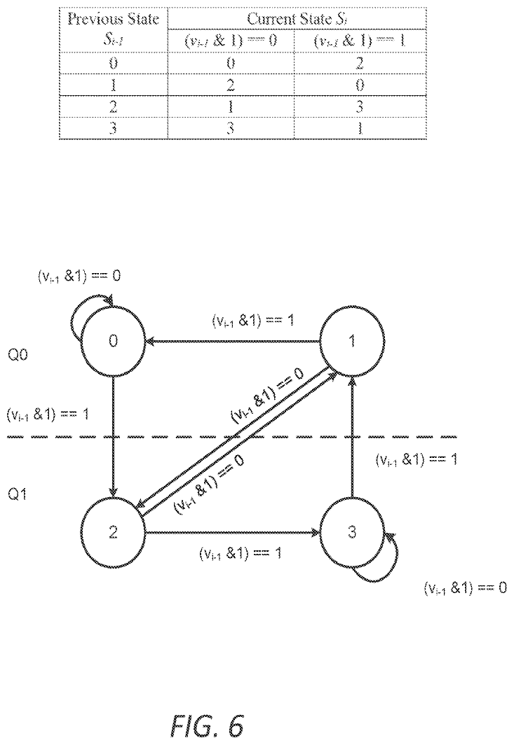

Instead of using the parity of level, the parity of level_context is used for controlling the state transition as shown in FIG. 6. As one example, if the previous state Sᵢ₋₁ is 0 and the parity of the level_context of the previous sample in the block, denoted as vᵢ₋₁, is even, the current state Sᵢ will be 0. If the previous state Sᵢ₋₁ is 0 and the parity of level_context of the previous sample in the block, vᵢ₋₁, is odd, the next state will be 2. The details of the state transition for other states are illustrated in FIG. 6.

Compared with the existing dependent quantization methods where the parity of the entire value of the previous quantization level is used to determine the state of the current sample, the proposed method in this example takes into account the encoding mechanism of the AV2 to reduce the delay in the dependent quantization. Further, there is no need to use the extra flag to indicate the parity of the previous level, thereby reducing the size of the compressed video and increasing the coding efficiency.

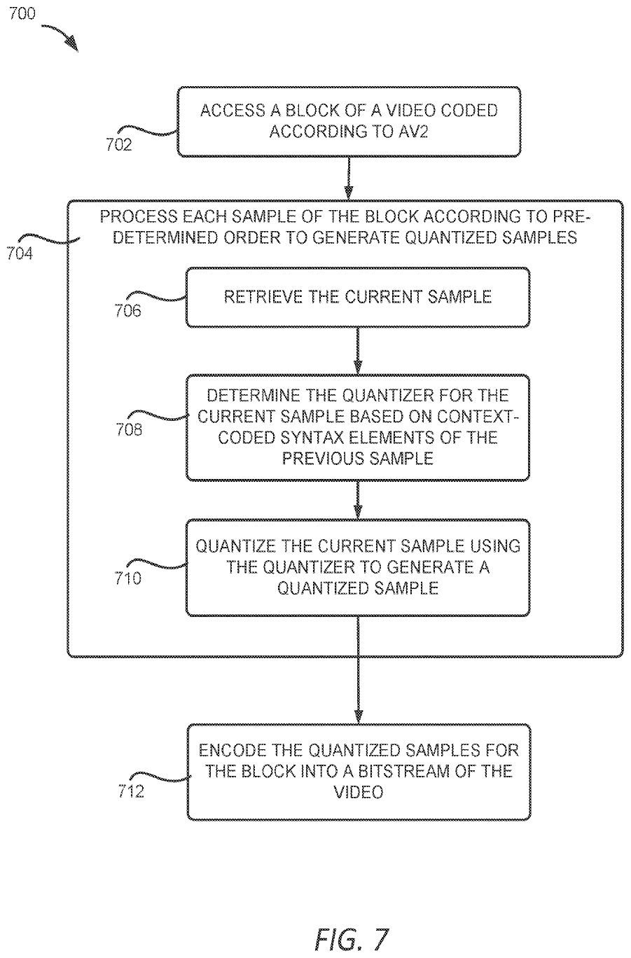

FIG. 7 depicts an example of a process 900 for encoding a block for a video via the dependent quantization, according to some embodiments of the present disclosure. One or more computing devices (e.g., the computing device implementing the video encoder 100) implement operations depicted in FIG. 7 by executing suitable program code (e.g., the program code implementing the quantization module 115). For illustrative purposes, the process 700 is described with reference to some examples depicted in the figures. Other implementations, however, are possible.

At block 702, the process 700 involves accessing a coding block (or block) of a video signal. The block can be a portion of a picture of the input video, such as a coding unit 402 discussed in FIG. 4 or any type of block processed by a video encoder as a unit when performing the quantization.

At block 704, which includes 706-710, the process 700 involves processing each sample of the block according to a pre-determined scanning order for the block (e.g., the scanning order discussed above) to generate quantized samples. A sample of a coding block may be a residual after inter- or intra-prediction. The sample may be a transform coefficient of the residual in a frequency domain or the value of the residual in the pixel domain.

At block 706, the process 700 involves retrieving the current sample according to the scanning order. If no sample has been quantized for the current block, the current sample will be the first sample in the block according to the scanning order. As discussed above, in some cases, the video encoder performs the quantization starting from the first non-zero sample in the block according to the scanning order. In those cases, the current sample will be the first non-zero sample in the block. If there are samples in the block that have been quantized, the current sample will be the sample after the last processed sample in the scanning order.

At block 708, the process 700 involves determining the quantizer for the current sample based on the context-coded syntax elements of the sample that precede the current sample. As discussed above, the quantizer can be selected according to a quantization state (or “state”) for the current sample. The quantization state for the current sample (“current state”) can be determined using a state transition table and a partial quantization value calculated based on the context-coded syntax elements of the sample preceding the current sample. The state transition table can be the table shown in FIG. 6. At block 710, the process 700 involves quantizing the current sample using the determined quantizer to generate a quantized sample.

At block 712, the process 700 involves encoding the quantized samples (quantization levels) of the block for inclusion in a bitstream of the video. The encoding may include entropy encoding as discussed above with respect to FIG. 1.

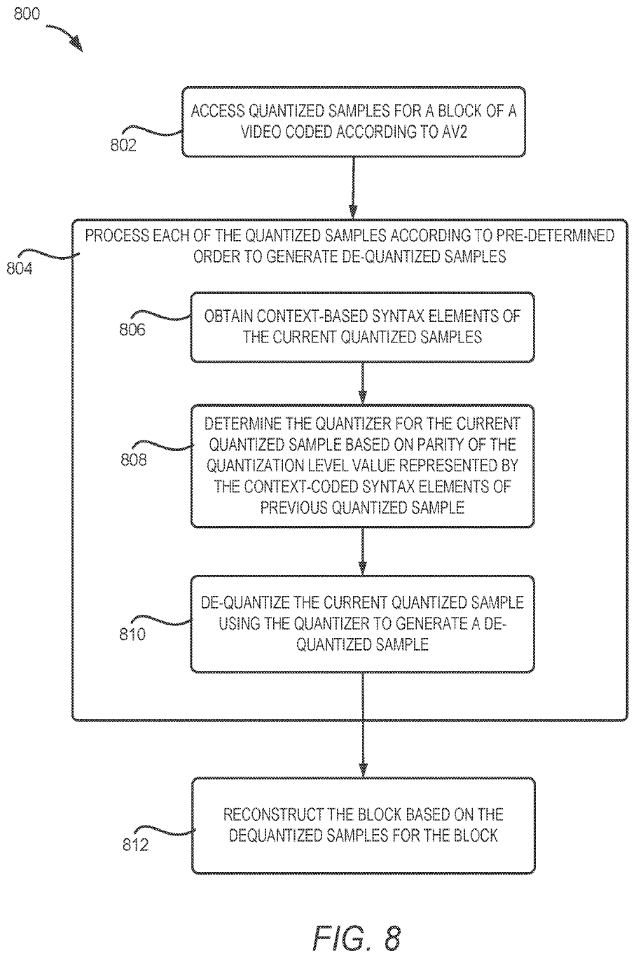

FIG. 8 depicts an example of a process 800 for reconstructing a block for a video via the dependent dequantization, according to some embodiments of the present disclosure. One or more computing devices implement operations depicted in FIG. 8 by executing suitable program code. For example, a computing device implementing the video encoder 100 may implement the operations depicted in FIG. 8 by executing the program code for the inverse quantization module 118. A computing device implementing the video decoder 200 may implement the operations depicted in FIG. 8 by executing the program code for the inverse quantization module 218. For illustrative purposes, the process 800 is described with reference to some examples depicted in the figures. Other implementations, however, are possible.

At block 802, the process 800 involves accessing quantized samples (quantization levels) of a coding block of a video signal. The block can be a portion of a picture of the input video, such as a coding unit 402 discussed in FIG. 4 or any type of block processed by a video encoder or decoder as a unit when performing the de-quantization. For an encoder, the quantized samples may be obtained by quantizing the samples of the block. For a decoder, the quantized samples may be obtained by performing entropy decoding on binary strings parsed from an encoded bitstream of the video.

At block 804, which includes 806-810, the process 800 involves processing each quantized sample of the block according to a pre-determined scanning order for the block (e.g., the scanning order as discussed above) to generate de-quantized samples. At block 806, the process 800 involves retrieving the current quantized sample according to the scanning order. If no quantized sample has been de-quantized for the current block, the current quantized sample will be the first quantized sample for the block according to the scanning order. As discussed above, in some cases, the video encoder performs the quantization starting from the first non-zero sample in the block according to the scanning order. In those cases, the first quantized sample will be the first non-zero quantization level in the block. If there are samples in the block that have been de-quantized, the current quantized sample will be the quantization level after the last de-quantized sample in the scanning order.

At block 808, the process 800 involves determining the quantizer for the current quantized sample based on the quantization levels that precede the current quantized sample. As discussed above, the quantizer can be selected according to a quantization state for the current quantized sample. The quantization state for the current quantized sample can be determined using a state transition table and a partial quantization value calculated based on the context-coded syntax elements of the sample preceding the current quantized sample. The state transition table can be the table shown in FIG. 6. At block 810, the process 800 involves de-quantizing the current quantized sample using the determined quantizer to generate a de-quantized sample.

At block 812, the process 800 involves reconstructing the block in the pixel domain based on the de-quantized samples of the block. The reconstruction may include inverse transform as discussed above with respect to FIGS. 1 and 2. The reconstructed block may also be used to perform intra- or inter-prediction for other blocks or pictures in the video by the encoder or the decoder as described above with respect to FIGS. 1 and 2. The reconstructed block may also be further processed to generate a decoded block for displaying along with other decoded blocks in the picture at the decoder side.

While the above description focusses on AV2 video coding standard, AV2 is used as an example and should be construed as limiting. The dependent quantization techniques presented herein can be applied to any residual coding where at least one quantization level has context-coded syntax elements and bypass-coded syntax elements associated therewith, such as JVET VVC and AVS-Video. As discussed in detail above, during this type of residual coding, only the context-coded syntax elements in a coding block can be used when selecting a quantizer for a current sample of the coding block, thereby allowing the quantization level to be decoded using inverse dependent quantization without waiting for the entire block to be decoded.

### Computing System Example for Implementing Dependent Quantization for AV2 Video Coding

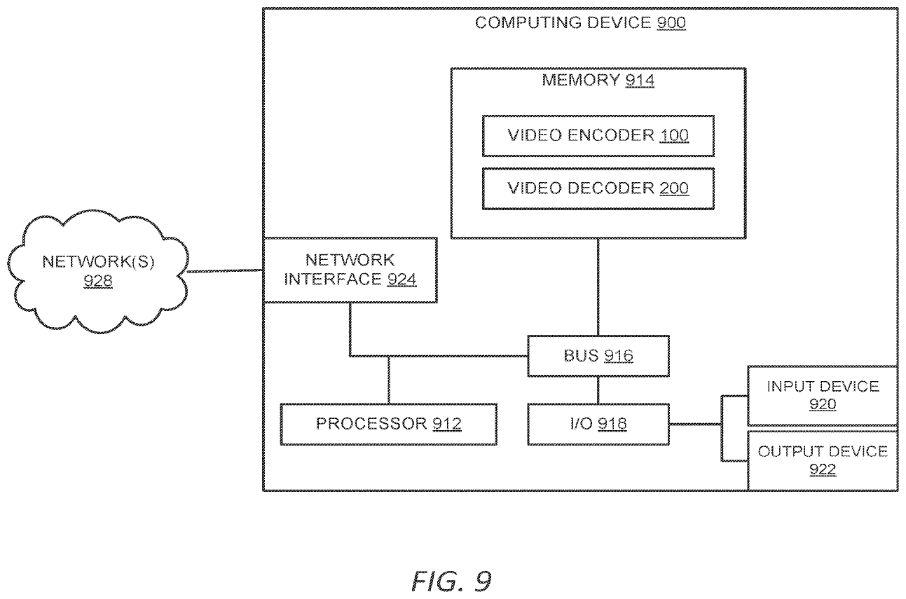

Any suitable computing system can be used for performing the operations described herein. For example, FIG. 9 depicts an example of a computing device 900 that can implement the video encoder 100 of FIG. 1 or the video decoder 200 of FIG. 2. In some embodiments, the computing device 900 can include a processor 912 that is communicatively coupled to a memory 914 and that executes computer-executable program code and/or accesses information stored in the memory 914. The processor 912 may comprise a microprocessor, an application-specific integrated circuit (“ASIC”), a state machine, or other processing device. The processor 912 can include any of a number of processing devices, including one. Such a processor can include or may be in communication with a computer-readable medium storing instructions that, when executed by the processor 912, cause the processor to perform the operations described herein.

The memory 914 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 900 can also include a bus 916. The bus 916 can communicatively couple one or more components of the computing device 900. The computing device 900 can also include a number of external or internal devices such as input or output devices. For example, the computing device 900 is shown with an input/output (“I/O”) interface 918 that can receive input from one or more input devices 920 or provide output to one or more output devices 922. The one or more input devices 920 and one or more output devices 922 can be communicatively coupled to the I/O interface 918. The communicative coupling can be implemented via any suitable manner (e.g., a connection via a printed circuit board, connection via a cable, communication via wireless transmissions, etc.). Non-limiting examples of input devices 920 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 922 include an LCD screen, an external monitor, a speaker, or any other device that can be used to display or otherwise present outputs generated by a computing device.

The computing device 900 can execute program code that configures the processor 912 to perform one or more of the operations described above with respect to FIGS. 1-8. The program code can include the video encoder 100 or the video decoder 200. The program code may be resident in the memory 914 or any suitable computer-readable medium and may be executed by the processor 912 or any other suitable processor.

The computing device 900 can also include at least one network interface device 924. The network interface device 924 can include any device or group of devices suitable for establishing a wired or wireless data connection to one or more data networks 928. Non-limiting examples of the network interface device 924 include an Ethernet network adapter, a modem, and/or the like. The computing device 900 can transmit messages as electronic or optical signals via the network interface device 924.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Some blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method for reconstructing a block for a video coded according to AOM enhanced compression model (AV2), the method comprising:
accessing a plurality of quantized samples of the block, each of the plurality of quantized samples associated with context-coded syntax elements and at least one of the plurality of quantized samples associated with bypass-coded syntax elements;
processing the plurality of quantized samples according to an order for the block to generate respective de-quantized samples, the processing comprising:
obtaining a current quantized sample of the block from the plurality of quantized samples;
determining a quantizer for the current quantized sample based on a parity of a first quantization level value represented by context-coded syntax elements of a previous quantized sample according to the order; and
de-quantizing the current quantized sample based on the quantizer to generate a de-quantized sample; and
reconstructing the block based on the de-quantized samples.

2. The method of claim 1, wherein the block comprises a coding unit.

3. The method of claim 1, wherein the quantized samples associated with the block comprise quantized pixels of the block or quantized transform coefficients of the block.

4. The method of claim 1, wherein the context-coded elements of a quantized sample comprise a base range syntax element, and one or more low range syntax elements, and wherein a number of the one or more low range syntax elements is smaller than or equally to four.

5. The method of claim 1, wherein the bypass-coded syntax elements of a quantized sample comprise high range syntax elements.

6. The method of claim 1, wherein a quantization level of a quantized sample that are associated with the context-coded syntax elements and the bypass-coded syntax elements is a sum of the first quantization level value presented by the context-coded elements and a second quantization level value represented by the bypass-coded syntax elements.

7. The method of claim 1, wherein a quantization level of a quantized sample that are associated with the context-coded syntax elements without the bypass-coded syntax elements is the first quantization level value represented by the context-coded elements.

8. A non-transitory computer-readable medium having program code that is stored thereon, the program code executable by one or more processing devices for performing operations comprising:
accessing a plurality of quantized samples of a block of a video coded according to AOM enhanced compression model (AV2), each of the plurality of quantized samples associated with context-coded syntax elements and at least one of the plurality of quantized samples associated with bypass-coded syntax elements;
processing the plurality of quantized samples according to an order for the block to generate respective de-quantized samples, the processing comprising:
obtaining a current quantized sample of the block from the plurality of quantized samples;
determining a quantizer for the current quantized sample based on a parity of a first quantization level value represented by context-coded syntax elements of a previous quantized sample according to the order; and
de-quantizing the current quantized sample based on the quantizer to generate a de-quantized sample; and
reconstructing the block based on the de-quantized samples.

9. The non-transitory computer-readable medium of claim 8, wherein the block comprises a coding unit.

10. The non-transitory computer-readable medium of claim 8, wherein the quantized samples associated with the block comprise quantized pixels of the block or quantized transform coefficients of the block.

11. The non-transitory computer-readable medium of claim 8, wherein the context-coded elements of a quantized sample comprise a base range syntax element, and one or more low range syntax elements, and wherein a number of the one or more low range syntax elements is smaller than or equally to four.

12. The non-transitory computer-readable medium of claim 8, wherein the bypass-coded syntax elements of a quantized sample comprise high range syntax elements.

13. The non-transitory computer-readable medium of claim 8, wherein a quantization level of a quantized sample that are associated with the context-coded syntax elements and the bypass-coded syntax elements is a sum of the first quantization level value presented by the context-coded elements and a second quantization level value represented by the bypass-coded syntax elements.

14-20. (canceled)

21. A method for encoding a block for a video coded according to AOM enhanced compression model (AV2), the method comprising:
accessing a plurality of samples associated with the block of the video;
processing the plurality of samples according to an order for the block, the processing comprising:
obtaining a current sample of the block from the plurality of samples;
determining a quantizer for the current sample based on a parity of a first quantization level value represented by context-coded syntax elements of a previous sample according to the order, the previous sample further associated with bypass-coded syntax elements representing a second quantization level value; and
quantizing the current sample based on the quantizer to generate a quantized sample; and
encoding the quantized samples into a bitstream representing the video.

22. The method of claim 21, wherein the block comprises a coding unit.

23. The method of claim 21, wherein the plurality of samples associated with the block comprise pixels of the block or transform coefficients of the block.

24. The method of claim 21, wherein the context-coded elements of the previous sample comprise a base range syntax element, and one or more low range syntax elements, and wherein a number of the one or more low range syntax elements is smaller than or equally to four.

25. The method of claim 21, wherein the bypass-coded syntax elements of the previous sample comprise high range syntax elements.

26. The method of claim 21, wherein a value of a quantization level of the previous sample is a sum of the first quantization value presented by the context-coded elements and the second quantization value represented by the bypass-coded syntax elements.

27. The method of claim 21, wherein a value of a quantization level of a sample of the plurality samples that is associated with context-coded syntax elements without bypass-coded syntax elements is a quantization level value represented by the context-coded elements.

28-40. (canceled)
